(19) United States
(12) Patent Application Publication
(10) Pub. No.: US 2003/0146853 A1
(43) Pub. Date: Aug. 7, 2003

(54) Apparatus for emergency aircraft guidance

(76) Inventor: Louis Bolduc, Columbia, MD (US)

Correspondence Address: HONEYWELL INTERNATIONAL, INC., LAW DEPARTMENT AB2, P.O. BOX 2245, MORRISTOWN, NJ, 07962-9806, US

(21) Appl. No.: 10/345,323

(22) Filed: Jan. 16, 2003

Related U.S. Application Data
(60) Provisional application No. 60/355,632, filed on Feb. 6, 2002.

(51) Int. Cl. G01C 21/00

(52) U.S. Cl. 340/974; 340/692

(57) ABSTRACT

A standby instrument, such as a standby attitude indicator, including a display, an attitude sensor module, and a speech synthesizer connected to the attitude sensor module. The standby instrument is controllable to cause the speech synthesizer to audibly speak attitude information generated by the attitude sensor module, thereby providing attitude information to a pilot even when a view of the standby instrument is impaired by, e.g., smoke.

This application claims the benefit of U.S. Provisional Application No. 60/355,632, filed Feb. 6, 2002, which is herein incorporated by reference in its entirety.

### BACKGROUND

1. Field of the Invention

The present invention relates generally to the field of air safety and more specifically to improvements in cockpit standby instruments.

2. Background of the Invention

Recent aircraft accidents and incidents have highlighted the problem of pilot disorientation when smoke fills the cockpit, often as a result of an electrical fault. For example, in 1998, a Swissair MD-11 crashed in the Atlantic Ocean off the coast of Nova Scotia. A post-accident analysis showed that all onboard electrical power was lost at about 10,000 feet. All instruments and displays requiring electrical power stopped, as well. Moreover, it is believed that the cockpit filled with smoke, even further complicating the situation.

In situations involving smoke, pilots are trained to lower the aircraft's altitude such that a window can be opened to help clear the smoke. Under many scenarios a pilot can reach over to an autopilot and command the aircraft to the desired lower altitude. However, an electrical fault can impair or even cause a total failure of the autopilot, thereby requiring the pilot to hand fly the aircraft. Alternatively, the pilot may elect to turn off all power in the cockpit, thereby also precluding use of the autopilot, and again, requiring the pilot to hand fly the aircraft to a lower altitude.

While hand flying may not be the most desirable option, pilots are nevertheless trained to do so by relying, at least in part, on so-called standby instruments, such as a standby attitude indicator. An attitude indicator helps a pilot to maintain control of an aircraft by indicating the aircraft's pitch (nose-up or nose-down) and roll (left-wing-up or left-wing-down) attitude.

According to FAA regulations, all commercial aircraft must have a standby attitude indicator that the pilot can use in emergencies, such as the types mentioned above. Standby attitude indicators, and standby instruments generally, have independent sources of power (i.e., batteries) that do not rely on cockpit power supplies. Such standby instruments, often integrated into a single package, are mounted in the cockpit along with standard avionics instrumentation packages. Under normal flying conditions, standby instruments can be used to verify the accuracy of standard avionics instruments.

Unfortunately, when hand-flying an aircraft with a smoke filled cockpit, it can be virtually impossible to see the standby instruments, even though the instruments may be functioning properly and could help the pilot to properly navigate. Indeed, it has been suggested that the pilots' inability to see their instruments was a significant cause of the crash of the Swissair aircraft.

There is, accordingly, a need to provide a more robust and dependable form of assistance to help pilots navigate an aircraft, especially in situations involving smoke that impairs the view of an instrument panel.

### BRIEF SUMMARY OF THE INVENTION

The present invention is directed to overcoming the above-noted, and other, deficiencies in the prior art by incorporating a speech synthesizer in a conventional standby instrument, such as a standby attitude indicator. In emergencies such as the one mentioned above, the standby instrument accordance with the present invention audibly calls out, speaks, or annunciates at least pitch and roll, and preferably also airspeed and altitude, information to the pilot. Thus, even if a pilot cannot see the standby instrument, the pilot will still receive the necessary information to properly fly the aircraft to, for example, reach a sufficiently low altitude at which a window can be opened.

In a preferred embodiment, the standby instrument in accordance with the present invention preferably has the same form factor and external connections as conventional standby instruments such that replacing the conventional type does not require any special cockpit modification. More specifically, the standby instrument of the present invention is preferably entirely self-contained, has an internal battery to keep it functional in the absence of power from the aircraft, and has the same display as conventional standby instruments. One significant potential visible external difference between the instrument of the present invention and the conventional type is the presence of a speaker or speakers on the face of the instrument, through which the audible cues are transmitted.

In one possible implementation, the synthesized speech functionality is activated if the display (or speakers with integrated switches) are touched by the fingers or hand of a crewmember. Each subsequent touch causes the volume of the voice to increase to, ultimately, a maximum volume, after which a subsequent touch preferably resets the volume to a lower level. In a possible implementation, the synthesizer functionality is shut-off by touching the display (or speaker) continuously for a period of time (e.g., 5-10 seconds). Those skilled in the art will appreciate that other forms of interaction that serve the purpose of activating and/or cutting-off the synthesizer are still considered to be within the scope of the present invention.

In accordance with a preferred embodiment of the invention, when the speech synthesizer is activated, pitch, roll, and preferably also airspeed and altitude, are spoken out every few seconds. As an example, the apparatus might annunciate the following: “pitch 20 degrees down,” “zero roll,” “400 knots,” “30,000 feet”.

In an alternative embodiment, the speech synthesizer is provided as an add-on device to a conventional standby instrument and can be mounted in a location different from the conventional standby unit.

Those skilled in the art will more fully appreciate the features of the present invention and the attendant advantages thereof upon reading the following detailed description in conjunction with the drawings.

### BRIEF DESCRIPTION OF THE DRAWINGS

FIG. 1 shows a standby instrument including speech synthesizer in accordance with the present invention.

FIG. 2 shows an alternative embodiment of the present invention in which the speech synthesizer is connected externally to a conventional standby instrument.

### DETAILED DESCRIPTION OF THE INVENTION

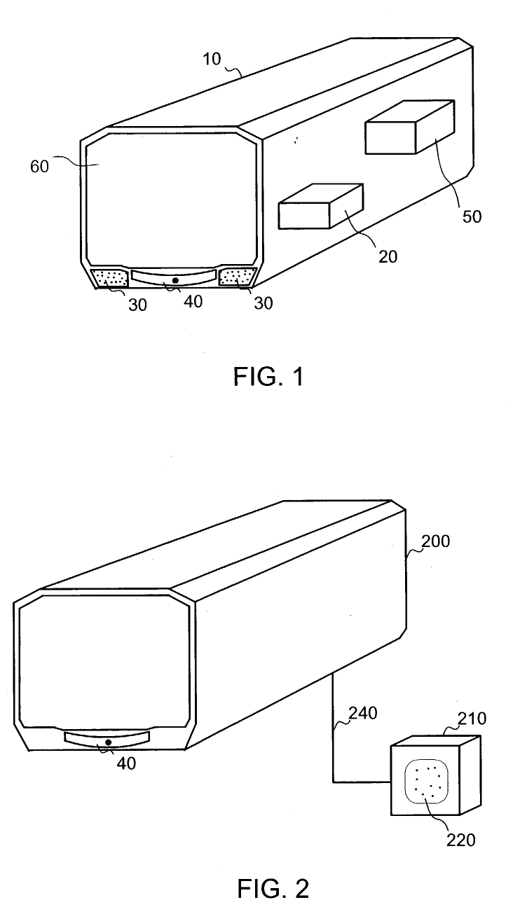

Referring to FIG. 1, a standby instrument with a built-in speech synthesizer is shown. The inventive standby instrument 10 preferably comprises a speech synthesizer 20, speakers 30, and an attitude sensor assembly 50, such as a two-axis fiber-optic gyroscope, and a slip ball 40. Slip ball 40, an instrument that is well-known in the art, can be positioned, for example, between speakers 30. Although not shown, an alternative embodiment preferably includes a single speaker only. A standby battery is also advantageously included, although also not shown in the drawings.

Given the high stress environment in which it would likely be necessary to activate a speech synthesizer associated with the standby instrument, the annunciation of the speech synthesizer is preferably limited to the minimum amount of information needed to maintain control and to, e.g., bring the aircraft safely to a lower altitude. Optionally, the present invention also provides the ability to program the type and order of information that is to be annunciated when speech synthesizer 20 is activated. In either case, the annunciation is preferably made with a soft, yet clear, voice to prevent inducing further stress on the crew.

In one embodiment of the present invention, each speaker 30 incorporates a switch that, when depressed by the pilot's finger, activates the voice output of the speech synthesizer (or mutes it). In another embodiment, a touch sensitive screen 60 may be used to activate the speech synthesizer. In either embodiment, depressing the switch or touching the screen 60 repeatedly preferably increases the volume, until a maximum volume is reached, after which further depressing/touching reduces the volume of annunciation. Deactivation of speech synthesizer 20 is preferably accomplished by continuously depressing the switch or touching the touch sensitive screen 60 for a continuous period of time, such as for 5 to 10 seconds. Of course, other activation and deactivation controls may be used in other implementations of the present invention, including stand-alone switches, or even voice commands.

The spoken annunciation from speech synthesizer 20 in accordance with the present invention advantageously includes pitch, roll, and preferably also airspeed, and altitude, information for the aircraft. Speech synthesizer 20 is preferably electrically connected to attitude sensor assembly or module 50 and includes, for example, a look up table that correlates the information generated by module 50 and the desired annunciation. Integrating speech synthesizers in this way is well known in the art. It is also noted that devices other than speech “synthesizers” can be used. For example, pre-recorded digitized speech segments could be employed. The term “speech synthesizer,” as used herein, is meant to encompass any device that is capable of generating audible calls consistent with the type of calls described below.

In a preferred embodiment, pitch and roll are annunciated (or called out) by the number of degrees, rounded to the nearest 5 degrees and by the term “Up ” or “Down” to indicate the nose direction. When the aircraft is pitching neither up nor down, the pitch annunciated could be “Zero Pitch.” Roll is preferably annunciated, again, by the number of degrees, but with the terms “Left” or “Right” to indicate left or right roll. “Zero Roll” could be annunciated when the aircraft is not rolling.

The airspeed is preferably annunciated to the nearest five knots, and the altitude is preferably annunciated in hundreds of feet (e.g., “Altitude Three Five Zero” to indicate an altitude of 35,000 feet). Of course, other types of annunciations are possible and still fall within the scope of the present invention. For example, at and below 1000 feet, annunciations may advantageously be expressed in tens of feet. This could be particularly helpful in night time emergency situations.

To enhance intelligibility, the information is preferably repeated in a precise order, such as pitch, roll, airspeed and altitude, with one second pauses between each information item and a five second pause placed between successive annunciations.

As mentioned above, the standby instrument of the present invention may also, be programmable such that the type and order of information that is annunciated can be pre-selected by a pilot. Programming can be accomplished via touch sensitive display 60.

It is noted that if the standby instrument of the present invention comprises the ability to display and annunciate airspeed and altitude (i.e., the instrument is more than just an “attitude” indicator), then an air data sensor is advantageously also built into the instrument. An air data sensor measures airspeed by way of air pressure, and further measures altitude by way of outside air pressure. Both of these measurements can be taken by electronic pressure transducers that are associated with an outside pitot tube and static air pressure port, by way of tubing, which is well known in the art. The important point in the context of the present invention is that data or simple electronic signals generated by the electronic pressure transducers can then be used as input to the speech synthesizer to generate the appropriate annunciations.

In another embodiment, the speech synthesizer is provided as an “add-on ” accessory to a conventional standby instrument. FIG. 2 shows a connection 240 between a conventional standby instrument 200 and a remote speech synthesizer 210 that could be mounted elsewhere in the cockpit and that operates in the same manner as described above. Activation and volume control can be controlled either at the conventional standby instrument 200 (with added functionality, e.g., touch screen display or switch) or at remote speech synthesizer 210 via speaker activation/volume switch 220. In this embodiment, remote speech synthesizer 210 is preferably powered by a battery associated with standby attitude indicator 200. In a variation of this embodiment, the speech synthesizer is incorporated into instrument 200, but a speaker is located remotely.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

What is claimed is:

1. A standby instrument, comprising:
a display;
an attitude sensor module; and
a speech synthesizer connected to the attitude sensor module,
wherein the speech synthesizer is operable to audibly speak at least a portion of attitude information generated by the attitude sensor module.

2. The standby instrument of claim 1, further comprising at least one speaker.

3. The standby instrument of claim 2, wherein an output of the speech synthesizer is activated by a switch associated with the at least one speaker.

4. The standby instrument of claim 1, wherein the display comprises a touch screen display.

5. The standby instrument of claim 1, wherein the volume of synthesized speech is controllable.

6. The standby instrument of claim 5, wherein the volume is controllable via the display.

7. The standby instrument of claim 1, further comprising a slip ball.

8. The standby instrument of claim 1, further comprising a battery.

9. The standby instrument of claim 1, wherein the standby attitude indicator is programmable to audibly speak pre-selected information generated by the attitude sensor module.

10. An emergency avionics instrument, comprising:
an attitude module; and
a speech synthesizer, the speech synthesizer operable to annunciate at least a portion of attitude information generated by the attitude module, wherein the activation and volume of the speech synthesizer are controllable.

11. The instrument of claim 10, further comprising a display that displays the attitude information generated by the attitude module.

12. The instrument of claim 11, wherein the display comprises a touch sensitive display.

13. The instrument of claim 10, further comprising at least one speaker.

14. The instrument of claim 13, wherein a switch associated with the at least one speaker controls the activation of the speech synthesizer.

15. The instrument of claim 10, further comprising a battery.

16. An emergency avionics system, comprising:
a standby instrument;
a speech synthesizer in electrical communication with the standby instrument; and
a speaker, connected to but not integral with the standby instrument, the speaker being driven by the speech synthesizer,
wherein the speech synthesizer is operable to annunciate at least a portion of information generated by the standby instrument.

17. The system of claim 16, wherein activation of the speech synthesizer is initiated by at least one of the standby instrument and the speaker.

18. The system of claim 16, wherein the information that is annunciated is preprogrammable.

19. The system of claim 16, wherein the volume of annunciation is controllable.

20. The system of claim 16, wherein at least pitch and roll information is annunciated.

21. The system of claim 16, wherein the speech synthesizer is powered by a battery associated with the standby attitude indicator.
